(19) United States
(12) Patent Application Publication
(10) Pub. No.: US 2015/0017496 A1
(43) Pub. Date: Jan. 15, 2015

(54) RECHARGEABLE BATTERY PACK

(71) Applicant: SAMSUNG SDI CO., LTD., Yongin-si (KR)

(72) Inventor: Hyung-Ho Kim, Yongin-si (KR)

(73) Assignee: SAMSUNG SDI CO., LTD., Yongin-si (KR)

(21) Appl. No.: 14/097,099

(22) Filed: Dec. 4, 2013

(30) Foreign Application Priority Data
Jul. 12, 2013 (KR) 10-2013-0082151

(51) Int. Cl. H01M 2/04; H01M 2/12

(52) U.S. Cl. CPC H01M 2/0404; H01M 2/043; H01M 2/1294; H01M 2220/20; H01M 2220/30
USPC 429/82

(57) ABSTRACT

A rechargeable battery pack forms an outlet at a pack cover to discharge a gas and an erupting material erupted from a unit cell. The rechargeable battery pack includes at least one unit cell including a rechargeable battery, and a pack cover covering the unit cell, where the pack cover forms an outlet corresponding to a cap plate side of the unit cell.

### RELATED APPLICATIONS

This application claims priority to, and the benefit of, Korean Patent Application No. 10-2013-0082151 filed in the Korean Intellectual Property Office on Jul. 12, 2013, the entire contents of which are incorporated herein by reference.

### BACKGROUND

1. Field

The described technology relates generally to a rechargeable battery pack including a pack cover.

2. Description of the Related Technology

Unlike a primary battery, a rechargeable battery can be repeatedly charged and discharged. A small-capacity rechargeable battery is used for small portable electronic devices such as mobile phones, notebook computers, camcorders, and the like, while a large-capacity rechargeable battery is used as a motor-driving power source for a hybrid vehicle and the like.

The rechargeable battery may be used as a single unit cell for driving a small electronic device, or as a pack in which a plurality of unit cells are electrically connected to each other like a cell for driving a motor. The rechargeable battery pack may be formed by connecting electrode terminals of unit cells to each other through bus bars. In the rechargeable battery pack, a pack cover typically covers upper portions of the unit cells to protect them from external foreign substances or to block electrical short-circuits.

The above information disclosed in this Background section is only for enhancement of understanding of the background of the described technology and therefore it may contain information that does not form the prior art that is already known in this country to a person of ordinary skill in the art.

### SUMMARY OF CERTAIN INVENTIVE ASPECTS

The described technology has been made in an effort to provide a rechargeable battery pack discharging gas and including an erupting material erupted from a unit cell by forming an outlet in a pack cover. Also, one embodiment provides a rechargeable battery pack that effectively discharges moisture generated in the pack cover.

A rechargeable battery pack according to an embodiment includes: at least one unit cell including a rechargeable battery; and a pack cover configured to cover the unit cell, wherein the pack cover includes an outlet corresponding to a cap plate side of the unit cell.

The rechargeable battery pack may further include a housing configured to receive the unit cell and having a first opening on the cap plate side.

The pack cover may be coupled to the first opening by a first coupling member.

The housing may include a first coupling hole corresponding to the first coupling member, and the pack cover may include a second coupling hole corresponding to the first coupling member.

The first coupling member may have a first coupling protrusion and a second coupling protrusion respectively coupled to the first coupling hole and the second coupling hole, and a separation portion between the first coupling protrusion and the second coupling protrusion to separate the housing and the pack cover, where the first coupling member has a larger diameter than the first coupling hole and the second coupling hole.

The first coupling hole may be formed at four corners of the housing, and the second coupling hole may be formed at a reinforcing portion of four corners of the pack cover.

The pack cover may include a second opening facing the first opening of the housing.

The first opening and the second opening may include a first gap in a direction crossing the cap plate by the first coupling member.

The first opening and the second opening may include a second gap in a direction parallel to the cap plate.

The pack cover may include a flat plate parallel to the cap plate at an opposite side of the second opening, and the outlet may be formed on the flat plate.

The pack cover may include a lateral plate forming the second opening and vertical to the flat plate.

The pack cover may further include an assistance cover facing the outlet side through the second coupling member and parallel to the flat plate.

The pack cover may include a pair of inclination plates respectively inclined on both sides of a length direction of the cap plate, and the outlet may be formed at a crossing portion of the pair of inclination plates.

The pack cover may include a lateral plate forming the second opening and inclined with respect to an extended plane of the cap plate.

The pack cover may further include an assistance cover facing the outlet side by the second coupling member and parallel to the pair of inclination plates.

The pack cover may further include an assistance cover facing the outlet side through the second coupling member and parallel to the cap plate.

Each of the pair of inclination plates may have a guide groove extending in an inclination direction at an inner surface thereof

According to embodiments, by providing the outlet at the pack cover covering the unit cell, the gas and the erupting material erupted in the unit cell may be effectively and stably discharged to the outlet. Also, the pack cover may discharge the moisture generated therein outside the unit cell.

### BRIEF DESCRIPTION OF THE DRAWINGS

FIG. 1 is an exploded perspective view illustrating a rechargeable battery pack according to a first embodiment.

FIG. 2 is a perspective view illustrating a unit cell applied to FIG. 1.

FIG. 3 is a cross-sectional view taken along line of FIG. 2.

FIG. 4 is a cross-sectional view taken along line IV-IV of FIG. 1.

FIG. 5 is a cross-sectional view of a rechargeable battery pack according to a second embodiment.

FIG. 6 is a cross-sectional view of a rechargeable battery pack according to a third embodiment.

FIG. 7 is a cross-sectional view of a rechargeable battery pack according to a fourth embodiment.

FIG. 8 is a cross-sectional view of a rechargeable battery pack according to a fifth embodiment.

FIG. 9 is a cross-sectional view of a rechargeable battery pack according to a sixth embodiment.

FIG. 10 is a cross-sectional view taken along line X-X of FIG. 9.

### DETAILED DESCRIPTION OF CERTAIN INVENTIVE EMBODIMENTS

The present embodiments will be described more fully hereinafter with reference to the accompanying drawings, in which certain embodiments of the invention are shown. As those skilled in the art would realize, the described embodiments may be modified in various ways, without departing from the spirit or scope of the present invention. The drawings and description are to be regarded as illustrative in nature and not restrictive. Like reference numerals generally designate like elements throughout the specification.

In rechargeable battery packs with a pack cover, the pack cover may close and seal cap plate parts of unit cells which limits discharge of gas and an erupting material erupted through a cap plate, and may contaminate adjacent unit cells due to erupting material of one unit cell.

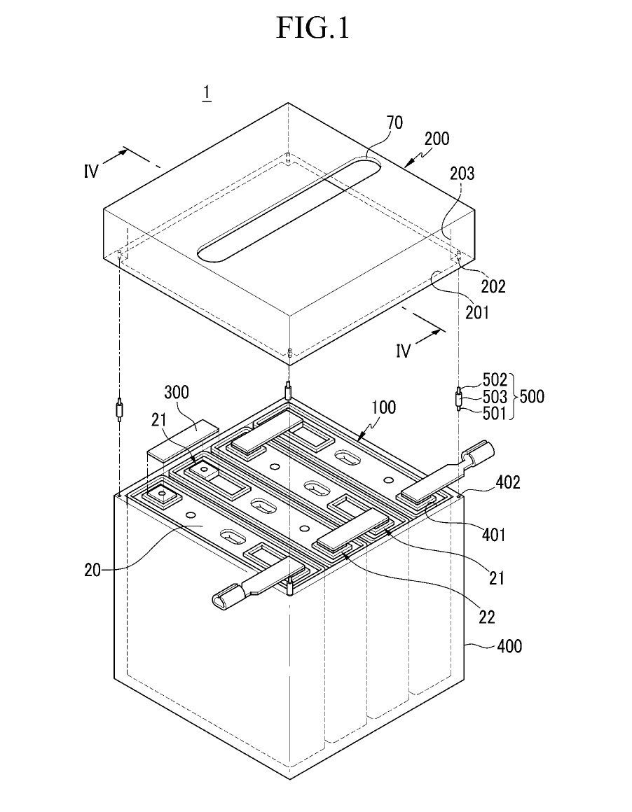

FIG. 1 is an exploded perspective view of a rechargeable battery pack according to the first embodiment of the present invention. Referring to FIG. 1, the rechargeable battery pack 1 includes a unit cell 100 composed of at least one rechargeable battery and a pack cover 200 covering the unit cell 100. The cover 200 includes an outlet 70 corresponding to a cap plate 20 side of the unit cell 100, and may discharge gas and an erupting material erupted from the unit cell 100 to the outside.

As shown in FIG. 1, when a plurality of unit cells 100 are used, the rechargeable battery pack 1 is configured by connecting a first and second electrode terminals 21 and 22 of unit cells 100 to each other by bus bars 300.

The rechargeable battery pack 1 further includes a housing 400 receiving the unit cells 100. The housing 400 includes a first opening 401 to open the cap plate 20 side of the received unit cells 100. The pack cover 200 includes a second opening 201 opposed to the first opening 401 of the housing 400.

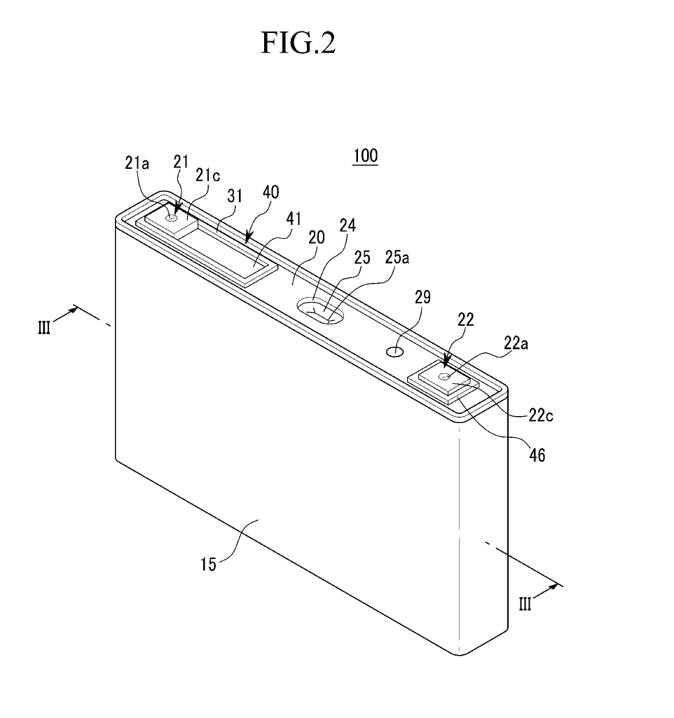

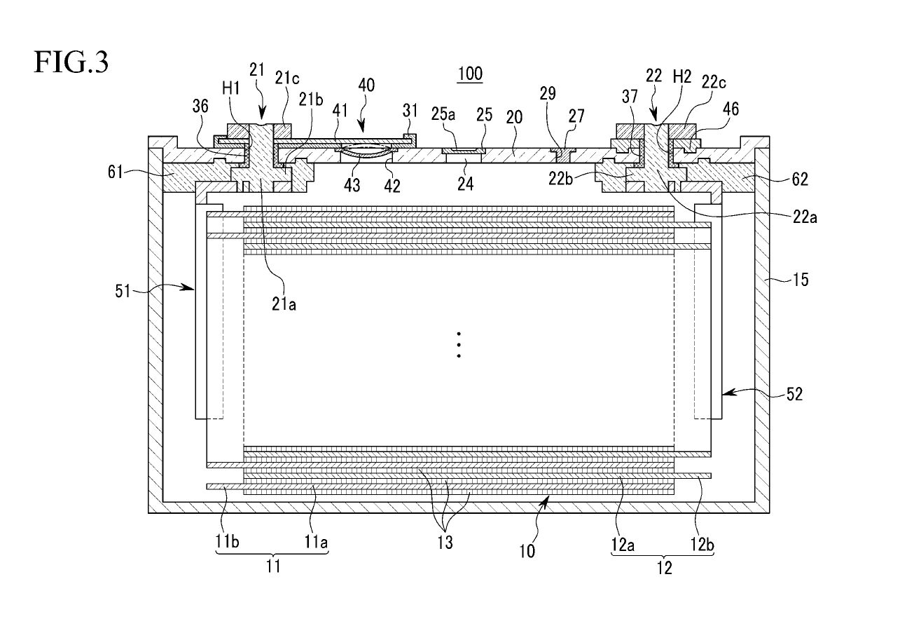

FIG. 2 is a perspective view illustrating a unit cell applied to FIG. 1, and FIG. 3 is a sectional view taken along line of FIG. 2. Referring to FIG. 2 and FIG. 3, the unit cell 100 includes an electrode assembly 10 charging and discharging an electric current, a case 15 receiving the electrode assembly 10, the cap plate 20 coupled with an opening of the case 15, the first electrode terminal (hereinafter referred to as “negative terminal”) 21 and the second electrode terminal (hereinafter referred to as “positive terminal”) 22 installed in the cap plate 20, and an external short-circuit part 40 provided at the negative terminal 21 side.

For example, the electrode assembly 10 is configured by disposing a first electrode (hereinafter referred to as “negative electrode”) 11 and a second electrode (hereinafter referred to as “positive electrode”) 12 at respective surfaces of a separator 13 being an insulator, and winding the negative electrode 11, the separator 13, and the positive electrode 12 in a jelly-roll configuration.

The negative electrode 11 and the positive electrode 12 include coated regions 11a and 12a where a current collector of a metal plate is coated with an active material, and uncoated regions 11b and 12b having an exposed current collector which is not coated with the active material, respectively.

The uncoated region 11b of the negative electrode 11 is formed at one end of the negative electrode 11 along the spirally wound negative electrode 11. The uncoated region 12b of the positive electrode 12 is formed at one end of the positive electrode 12 along the spirally wound positive electrode 12. The uncoated regions 11b and 12b are disposed at opposite ends of the electrode assembly 10.

In some embodiments, the case 15 is configured to have a substantially cubic shape to form a space for receiving the electrode assembly 10 and an electrolyte solution, and an opening connecting an inner space to the outside is formed on one surface of the cuboid. The opening enables the electrode assembly 10 to be inserted into the case 15.

The cap plate 20 is installed at the opening of the case 15 to close and seal the case 15. For example, the case 15 and the cap plate 20 are formed of aluminum so that the case 15 and the cap plate 20 may be welded to each other.

Further, the cap plate 20 includes an electrolyte injection opening 29, a vent hole 24, and terminal holes H1 and H2. After the cap plate 20 is coupled with the case 15, the electrolyte injection opening 29 may be used to inject the electrolyte solution into the case 15. After injecting the electrolyte solution, the electrolyte injection opening 29 is sealed by a sealing stopper 27.

The vent hole 24 is closed and sealed with a vent plate 25 so that internal pressure of the unit cell 100 may be discharged. If the internal pressure of the unit cell 100 reaches a predetermined pressure, the vent plate 25 is cut to open the vent hole 24. The vent plate 25 includes a notch 25a for inducing the cut.

The negative terminal 21 and the positive terminal 22 are installed in the terminal holes H1 and H2 of the cap plate 20 and are electrically connected to the electrode assembly 10. For example, the negative terminal 21 is electrically connected to the negative electrode 11 of the electrode assembly 10, and the positive terminal 22 is electrically connected to the positive electrode 12 of the electrode assembly 10. Accordingly, the electrode assembly 10 is drawn outside the case through the negative terminal 21 and the positive terminal 22.

Since the negative terminal 21 and the positive terminal 22 form the same structure at an inner side of the cap plate 20, the same structure is equally described. Since the negative terminal 21 and the positive terminal 22 form mutually different structures at an outer side of the cap plate 20, the different structures are separately described.

The negative and positive terminals 21 and 22 include rivet terminals 21a and 22a installed in the terminal holes H1 and H2 of the cap plate 20, flanges 21b and 22b integrally and widely formed in the rivet terminals 21a and 22a at an inner side of the cap plate 20, and plate terminals 21c and 22c connected to the rivet terminals 21a and 22a which are disposed at the outer side of the cap plate 20 through riveting or welding.

Negative and positive gaskets 36 and 37 are installed between the rivet terminals 21a and 22a and inner surfaces of the terminal holes H1 and H2 of the cap plate 20.

The gaskets 36 and 37 seal a space between the rivet terminals 21a and 22a and the cap plate 20, and electrically insulate the rivet terminals 21a and 22a from the cap plate 20.

The negative and positive gaskets 36 and 37 extend between the flanges 21b and 22b and an inner surface of the cap plate 20, further sealing the space between the flanges 21b and 22b and the cap plate 20, and electrically insulating the flanges 21b and 22b from the cap plate 20. For example, the negative and positive gaskets 36 and 37 prevent the electrolyte solution from leaking through the terminal holes H1 and H2 when installing the negative and positive terminals 21 and 22 in the cap plate 20.

Negative and positive electrode lead tabs 51 and 52 electrically connect the negative and positive terminals 21 and 22 to the negative and positive electrodes 11 and 12 of the electrode assembly 10, respectively. For example, by coupling the lead tabs 51 and 52 to a lower end portion of the rivet terminals 21a and 22a and by caulking the lower end portion, the lead tabs 51 and 52 are connected to the lower end portion of the rivet terminals 21a and 22a while being supported by the flanges 21b and 22b.

Negative and positive insulating members 61 and 62 are installed between the negative and positive electrode lead tab 51 and 52 and the cap plate 20 to electrically insulate the negative and positive electrode lead tabs 51 and 52 from the cap plate 20. Further, one side of each of the negative and positive insulation members 61 and 62 is coupled with the cap plate 20, and the other side thereof surrounds the negative and positive electrode lead tabs 51 and 52, the rivet terminals 21a and 22a, and the flanges 21b and 22b so that the connection structure thereof is stabilized.

The external short-circuit part 40 is described in connection with the plate terminal 21c of the negative terminal 21, and a top plate 46 is described in connection with the plate terminal 22c of the positive electrode terminal 22.

The external short-circuit part 40 of the negative terminal 21 side includes a short-circuit tab 41 and a short-circuit member 43 which are spaced or shorted according to internal pressure. The short-circuit tab 41 is electrically connected to the rivet terminal 21a of the negative terminal 21, and is disposed at an outer side of the cap plate 20 with an insulation member 31 interposed therebetween.

The insulation member 31 is installed between the short-circuit tab 41 and the cap plate 20 to electrically insulate the short-circuit tab 41 from the cap plate 20. For example, the cap plate 20 maintains a state of electrical insulation from the negative terminal 21.

The short-circuit tab 41 and the plate terminal 21c are coupled to the upper end of the rivet terminal 21 a and the upper end is caulked such that the short-circuit tab 41 and the plate terminal 21 c are coupled to the upper end of the rivet terminal 21a. Accordingly, the short-circuit tab 41 and the plate terminal 21 c are fixed to the cap plate 20 while interposing the insulation member 31 therebetween.

The short-circuit member 43 is installed in a short-circuit hole 42 which is formed in the cap plate 20. The short-circuit tab 41 is connected to the negative terminal 21 and extends along an outer side of the short-circuit member 43. Accordingly, the short-circuit tab 41 and the short-circuit member 43 correspond to the short-circuit hole 42 and face each other to maintain a spaced state (solid line state). When internal pressure of the unit cell 100 is increased, a short-circuit state (imaginary line state) may be formed by inversion of the short-circuit member 43.

The top plate 46 of the positive terminal 22 side electrically connects the plate terminal 22c of the positive terminal 22 to the cap plate 20. For example, the top plate 46 is interposed between the plate terminal 22c and the cap plate 20, and is formed through the rivet terminal 22a.

Accordingly, the top plate 46 and the plate terminal 22c are coupled with an upper end of the rivet terminal 22a to caulk the upper end of the rivet terminal 22a, so that the top plate 26 and the plate terminal 22c are coupled with a upper end of the rivet terminal 22a. The plate terminal 22c is installed at an outer side the cap plate 20 while interposing the top plate 46 therebetween.

The positive gasket 37 further extends between the rivet terminal 22a and the plate 46. The positive gasket 37 prevents the rivet terminal 22a from being directly electrically connected to the top plate 46. For example, the rivet terminal 22a is electrically connected to the top plate 46 through the plate terminal 22c.

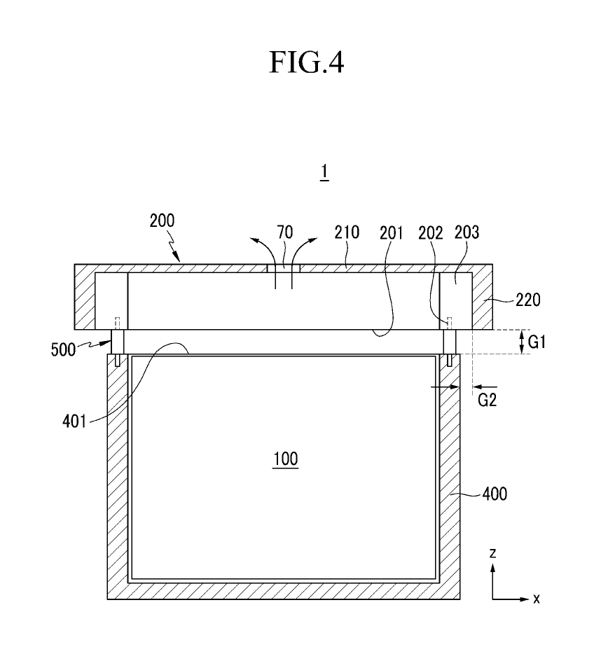

FIG. 4 is a cross-sectional view taken along line IV-IV of FIG. 1. Referring to FIG. 1 and FIG. 4, the pack cover 200 is installed at the first opening 401 side of the housing 400 by a first coupling member 500. A first coupling hole 402 is formed in the housing 400 corresponding to the first coupling member 500, and a second coupling hole 202 is formed in the pack cover 200 corresponding to the first coupling member 500.

The first coupling member 500 includes a first coupling protrusion 501 and a second coupling protrusion 502 respectively coupled with the first coupling hole 402 and the second coupling hole 202, and includes a separation part 503 provided between the first and second coupling protrusions 501 and 502.

The separation part 503 is formed to have a larger diameter than diameters of the first coupling hole 402 and the second coupling hole 202, the first coupling protrusion 501 is press-fit into the first coupling hole 402 of the housing 400, the second coupling protrusion 502 is press-fit into the second coupling hole 202, and the pack cover 200 is coupled with the housing 400 while being spaced apart from each other.

The first coupling hole 402 may be formed at four corners of the housing 400, and the second coupling hole 202 may be formed at a reinforcing portion 203 provided at four corners of the pack cover 200. Accordingly, the pack cover 200 may be stably fixed and installed on the housing 400.

The pack cover 200 includes a flat plate 210 that is formed parallel with the cap plate 20 at an opposite side of the second opening 201, and the outlet 70 is formed at the flat plate 210. The pack cover 200 includes a lateral plate 220 forming the second opening 201 and formed vertically to the flat plate 210.

Because of the first coupling member 500, a first gap G1 is formed between the first opening 401 of the housing 400 and the second opening 201 of the pack cover 200 in a direction (z-axis direction) crossing the cap plate 20. The first gap G1 is formed between the lateral plate 220 and an upper end of the housing 400 by a length of the separation part 503 of the first coupling member 500.

Also, the first opening 401 of the housing 400 and the second opening 201 of the pack cover 200 forms a second gap G2 spaced in a direction (x-axis direction) parallel to the cap plate 20. The second gap G2 is formed between an inner surface of the lateral plate 220 and an outer surface of the upper end of the housing 400.

In the rechargeable battery pack 1 of the first embodiment, through operation (short-circuit) of the external short-circuit part 40 and an operation (cut) of the vent plate 25, the gas erupted outward from the cap plate 20 inside the unit cell 100 is discharged outward through the outlet 70 of the pack cover 200.

In this case, a discharge material (such as, for example, an electrolyte solution) discharged together with the gas or moisture generated by dew condensation in the pack cover 200 is induced according to the inner surface of the pack cover 200 and is discharged through the first and second gaps G1 and G2. Accordingly, by discharging the material discharged from the unit cell 100, secondary pollution of the neighboring unit cell 100 may be prevented.

In the first embodiment, a single outlet 70 is formed at the flat plate 210 to correspond to the entirety of a plurality of unit cells 100. Although not shown, the pack cover may include a cell barrier corresponding to each unit cell in the inner surface of the flat plate, and a plurality of outlets may be formed corresponding to the vent hole and the external short-circuit part of each unit cell. In this case, the secondary pollution of the unit cell may be further effectively prevented.

Hereafter, various embodiments of the present invention will be described, and the description of the same elements as in the first embodiment will be omitted when describing subsequent embodiments, and differences will be described.

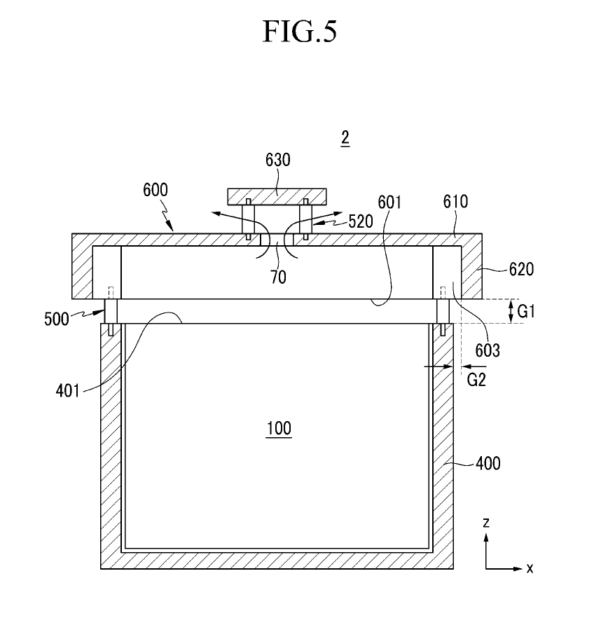

FIG. 5 is a cross-sectional view of a rechargeable battery pack according to a second embodiment of the present invention. Referring to FIG. 5, in the rechargeable battery pack 2 according to the second embodiment, a pack cover 600 further includes an assistance cover 630 installed at the outlet 70 side through a second coupling member 520 and parallel to the flat plate 610.

The second coupling member 520 spaces the outlet 70 of the flat plate 610 and the assistance cover 630 in the z-axis direction. For example, the outlet 70 is connected between the flat plate 610 and the assistance cover 630 to be opened at the side.

In the rechargeable battery pack 2, the gas erupted from the unit cell 100 is discharged outward through the outlet 70 of the pack cover 600 by the operation of the external short-circuit part 40 and the operation of the vent plate 25.

The gas and the discharge material discharged to the outlet 70 are induced to the side of the outlet 70 by the assistance cover 630. The assistance cover 630 guides the discharge of the gas while preventing a foreign material from being flowing into the outlet 70.

In this case, the electrolyte solution discharged together with the gas or the moisture generated by the dew condensation in the pack cover 600 is induced according to the inner surface of the pack cover 600 and is discharged through the first and second gaps G1 and G2.

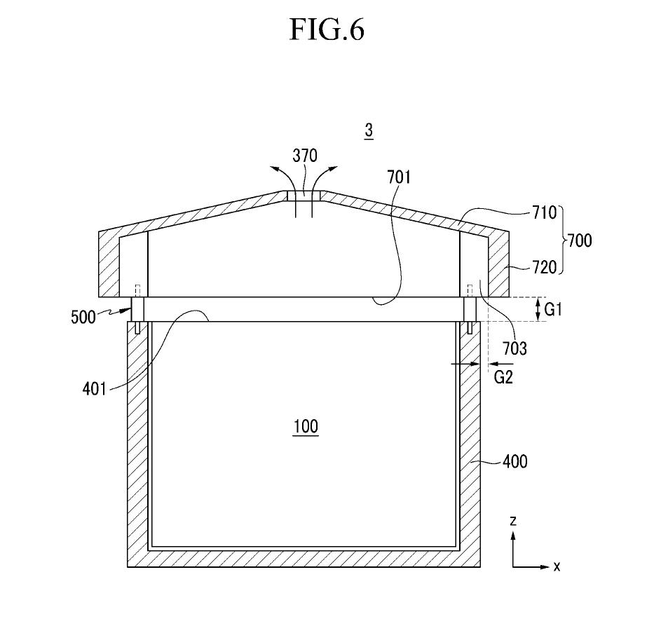

FIG. 6 is a cross-sectional view of a rechargeable battery pack according to a third embodiment of the present invention. Referring to FIG. 6, in the rechargeable battery pack 3 according to the third embodiment, a pack cover 700 includes inclination plates 710 inclined to both sides with respect to a length direction (x-axis direction) of the cap plate 20 at opposite sides of a second opening 701, and forms an outlet 370 at an intersection portion of the two inclination plates 710.

In the rechargeable battery pack 3, the gas erupted inside the unit cell 100 is discharged outward through the outlet 370 of the pack cover 700 by the operation of the external short-circuit part 40 and the operation of the vent plate 25. In this case, the gas is effectively induced through the inclination plates 710 to be discharged to the outlet 370.

The electrolyte solution discharged together with the gas or the moisture generated by the dew condensation in the pack cover 700 is induced according to the inner surface of the inclination plates 710 of the pack cover 700 into a lateral plate 720 and is discharged through the first and second gaps G1 and G2. Accordingly, by the discharge material discharged from the unit cell 100, secondary pollution of the neighboring unit cells 100 may be prevented.

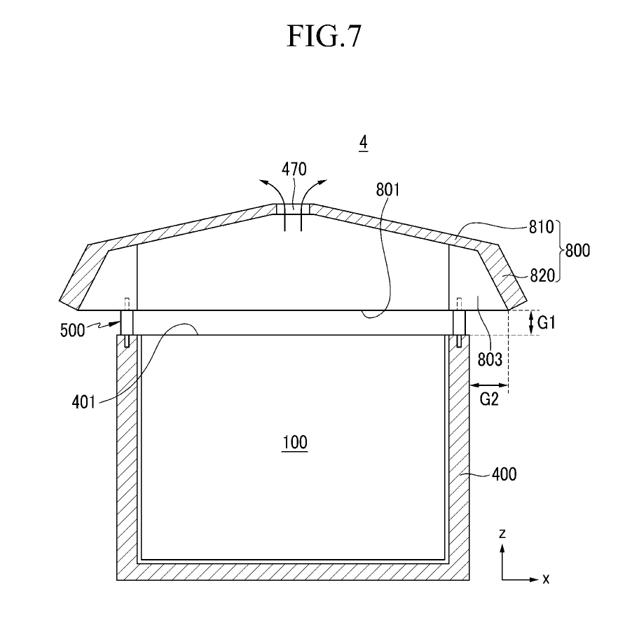

FIG. 7 is a cross-sectional view of a rechargeable battery pack according to a fourth embodiment of the present invention. Referring to FIG. 7, in the rechargeable battery pack 4 according to the fourth embodiment, a pack cover 800 forms lateral plates 820 forming a second opening 801 with an inclined state at an extended plane of the cap plate 20. The lateral plates 820 are inclined in a direction away from the first opening 401.

In the rechargeable battery pack 4, the gas erupted inside the unit cell 100 is discharged outward through an outlet 470 of the pack cover 800 by the operation of the external short-circuit part 40 and the operation of the vent plate 25. In this case, the gas is effectively induced through inclination plates 810 to be discharged to the outlet 470.

The electrolyte solution discharged together with the gas or the moisture generated by the dew condensation in the pack cover 800 is induced according to the inner surface of the inclination plates 810 of the pack cover 800 into the lateral plates 820 and is discharged through the first and second gaps G1 and G2. The lateral plates 820 are obliquely connected to the inclination plates 810 such that the electrolyte solution or the moisture may be naturally induced from the inclination plates 810 to the lateral plates 820.

The inclination plates 810 and the lateral plates 820 are connected with an obliquely bent shape, as shown. Although not shown, the inclination plates and the lateral plates may be connected with a curved surface shape (not shown) such that the discharged electrolyte solution or moisture may be stably induced.

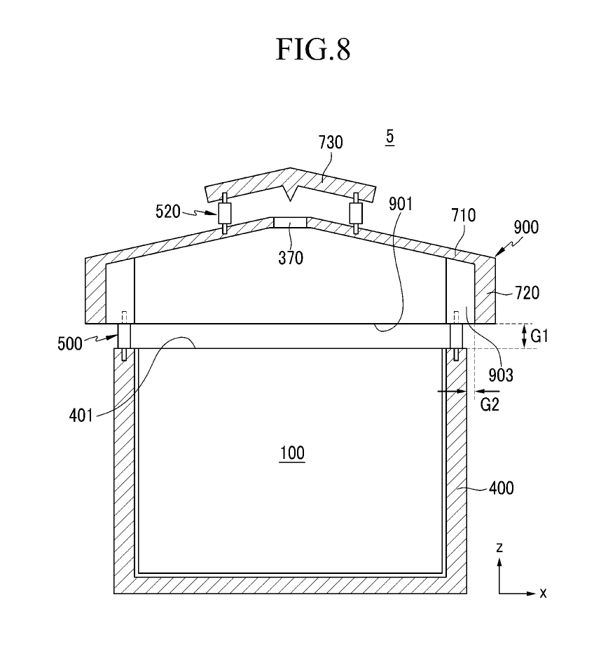

FIG. 8 is a cross-sectional view of a rechargeable battery pack according to a fifth embodiment of the present invention. Referring to FIG. 8, in the rechargeable battery pack 5 according to the fifth embodiment, a pack cover 900 further includes an assistance cover 730 installed at the outlet 370 side through the second coupling member 520 and inclined to be parallel to the inclination plate 710.

The second coupling member 520 separates the outlet 370 of the inclination plate 710 from the assistance cover 730 in the z-axis direction. For example, the outlet 370 is connected between the inclination plate 710 and the assistance cover 730 thereby being opened at the side.

In the rechargeable battery pack 5, the gas erupted inside the unit cell 100 is discharged outward through the outlet 370 of the pack cover 900 by the operation of the external short-circuit part 40 and the operation of the vent plate 25. In this case, the gas is effectively induced through the inclination plate 710 to be discharged to the outlet 370.

The gas discharged to the outlet 370 is induced to the side of the outlet 370 by the inclined assistance cover 730. The assistance cover 730 guides the discharge of the gas while preventing the foreign material from flowing into the outlet 370.

In this case, the electrolyte solution discharged together with the gas or the moisture generated by the dew condensation in the pack cover 900 is induced according to the inner surface of the inclination plate 710 of the pack cover 900 to the lateral plate 720 and is discharged through the first and second gaps G1 and G2.

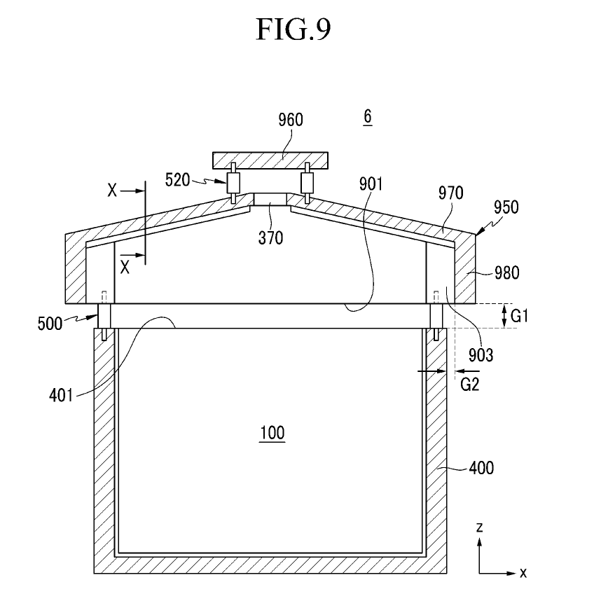

FIG. 9 is a cross-sectional view of a rechargeable battery pack according to a sixth embodiment of the present invention. Referring to FIG. 9, in the rechargeable battery pack 6, a pack cover 950 further includes an assistance cover 960 installed at the outlet 370 side through the second coupling member 520 and parallel to the cap plate 20.

The second coupling member 520 separates the outlet 370 of an inclination plate 970 and the assistance cover 960 in the z-axis direction. For example, the outlet 370 is formed between the inclination plate 970 and the assistance cover 960 thereby being opened at the side.

In the rechargeable battery pack 6, the gas erupted inside the unit cell 100 is discharged outward through the outlet 370 of the pack cover 950 by the operation of the external short-circuit part 40 and the operation of the vent plate 25.

The gas discharged to the outlet 370 is induced to the side of the outlet 370 by the assistance cover 960. The assistance cover 960 guides the discharge of the gas while preventing the foreign material from flowing into the outlet 370.

In this case, the electrolyte solution discharged together with the gas or the moisture generated by the dew condensation in the pack cover 950 is induced according to the inner surface of the pack cover 950 and is discharged through the first and second gaps G1 and G2.

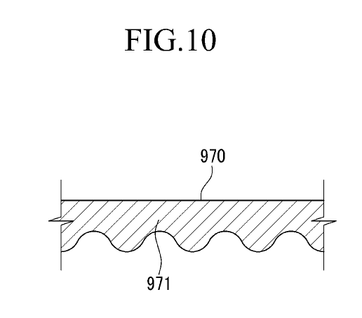

FIG. 10 is a cross-sectional view taken along the line X-X of FIG. 9. Referring to FIG. 10, the inclination plate 970 has a guide groove 971 extended in the inclination direction at the inner surface thereof. The electrolyte solution or the moisture generated by the dew condensation in the pack cover 950 is induced according to the inner surface of the pack cover 950 and is discharged to the first and second gaps G1 and G2.

The guide groove 971 may further stably induce the electrolyte solution and the moisture to a lateral plate 980. Although not shown, an additional guide groove connected to the guide groove 971 is further provided at an inner surface of the lateral plate 980 such that the electrolyte solution and the moisture may be further stably guided till the end of the lateral plate 980.

While this invention has been described in connection with certain embodiments, it is to be understood that the invention is not limited to the disclosed embodiments, but, on the contrary, is intended to cover various modifications and equivalent arrangements included within the spirit and scope of the appended claims.

What is claimed is:

1. A rechargeable battery pack comprising:
at least one unit cell including a rechargeable battery; and
a pack cover configured to cover the unit cell,
wherein the pack cover comprises an outlet corresponding to a cap plate side of the unit cell.

2. The rechargeable battery pack of claim 1, further comprising
a housing configured to receive the unit cell and having a first opening on the cap plate side.

3. The rechargeable battery pack of claim 2, wherein
the pack cover is coupled to the first opening by a first coupling member.

4. The rechargeable battery pack of claim 3, wherein
the housing comprises a first coupling hole corresponding to the first coupling member, and
the pack cover comprises a second coupling hole corresponding to the first coupling member.

5. The rechargeable battery pack of claim 4, wherein
the first coupling member has a first coupling protrusion and a second coupling protrusion respectively coupled to the first coupling hole and the second coupling hole, and
wherein the first coupling member further includes a separation portion between the first coupling protrusion and the second coupling protrusion to separate the housing and the pack cover, wherein the first coupling member has a larger diameter than the first coupling hole and the second coupling hole.

6. The rechargeable battery pack of claim 4, wherein
the first coupling hole is formed at four corners of the housing, and
the second coupling hole is formed at a reinforcing portion of four corners of the pack cover.

7. The rechargeable battery pack of claim 2, wherein
the pack cover comprises a second opening facing the first opening of the housing.

8. The rechargeable battery pack of claim 7, wherein
the first opening and the second opening include a first gap in a direction crossing the cap plate by the first coupling member.

9. The rechargeable battery pack of claim 7, wherein
the first opening and the second opening include a second gap in a direction parallel to the cap plate.

10. The rechargeable battery pack of claim 7, wherein
the pack cover comprises a flat plate parallel to the cap plate at an opposite side of the second opening and wherein the outlet is formed on the flat plate.

11. The rechargeable battery pack of claim 10, wherein
the pack cover comprises a lateral plate forming the second opening and vertical to the flat plate.

12. The rechargeable battery pack of claim 10, wherein
the pack cover further comprises an assistance cover facing the outlet side through the second coupling member and parallel to the flat plate.

13. The rechargeable battery pack of claim 7, wherein
the pack cover comprises a pair of inclination plates respectively inclined on both sides of a length direction of the cap plate, and wherein the outlet is formed at a crossing portion of the pair of inclination plates.

14. The rechargeable battery pack of claim 13, wherein
the pack cover comprises a lateral plate forming the second opening and inclined with respect to an extended plane of the cap plate.

15. The rechargeable battery pack of claim 13, wherein
the pack cover further comprises an assistance cover facing the outlet side by the second coupling member and parallel to the pair of inclination plates.

16. The rechargeable battery pack of claim 13, wherein
the pack cover further comprises an assistance cover facing the outlet side by the second coupling member and parallel to the cap plate.

17. The rechargeable battery pack of claim 13, wherein
each of the pair of inclination plates has a guide groove extending in an inclination direction at an inner surface thereof.
